(19) United States
(12) Patent Application Publication
(10) Pub. No.: US 2007/0174522 A1
(43) Pub. Date: Jul. 26, 2007

(54) Universal interface apparatus and method

(76) Inventor: Ki-Jong Lee, Yongin-si (KR)

Correspondence Address: LAW OFFICE OF MONICA H CHOI, P O BOX 3424, DUBLIN, OH, 430160204, US

(21) Appl. No.: 11/698,384

(22) Filed: Jan. 26, 2007

(30) Foreign Application Priority Data
Jan. 26, 2006 (KR) 2006-08355

(51) Int. Cl. G06F 13/38

(52) U.S. Cl. 710/62

(57) ABSTRACT

A universal interface apparatus includes a standard detection unit, a physical interface unit, and a data link selection unit. The standard detection unit automatically determines a specific physical layer standard for an external device. The physical interface unit has an I/0 (input/output) terminal that uses a respective set of the components according to the specific physical layer standard. The data link selection unit uses a respective data link layer standard corresponding to the specific physical layer standard.

### BACKGROUND OF THE INVENTION

This application claims priority to Korean Patent Application No. 2006-08355, filed on Jan. 26, 2006 in the Korean Intellectual Property Office, the disclosure of which is incorporated herein in its entirety by reference.

1. Field of the Invention

The present invention relates generally to interfacing between electronic devices, and more particularly to a universal interface apparatus and method for exchanging data with an external device operating according to any of a multiple of physical layer standards.

2. Description of the Related Art

Nowadays, mobile devices (such as cellular phones) have multimedia functions such as those of a camera, an MP3 player and so on, in addition to communication functions. A mobile device is generally coupled to a liquid crystal device (LCD) panel for displaying pictures, a camera for capturing a still/moving image, and a memory device for storing the still/moving image.

A conventional interface between the mobile device and an external device, such as the LCD panel, the camera, and the memory device, is generally classified as either a serial interface or a parallel interface.

A serial interface is widely used in a mobile device because the serial interface may operate at fast transfer speed. A serial interface may be for a Mobile Display Digital Interface (MDDI), a Mobile Industry Processor Interface (MIPI), a Mobile Graphic Coprocessor Interface (MGCI), or a compact camera port (CCP) interface

FIG. 1 is a block diagram of a conventional image processing unit in a mobile device. Referring to FIG. 1, the image processing unit includes a digital signal processor (DSP) 110, a system memory 120, a bus 130, a camera interface 140, a memory interface 150, and a display interface 160.

The DSP 110 is a front-end processor for processing the image data such as for compression and/or decompression of the image data. For example, the DSP 110 receives the image data from a camera to perform compression on the received image data. Additionally, the DSP 110 may be an advanced reduced instruction set computer (RISC) machine (ARM) processor that is included in a system-on-chip (SOC).

The system memory 120 is a storage device for temporarily storing an original image data or a compressed image data from the DSP 110. For example, the system memory 120 may be a dynamic random-access memory (DRAM) or a static random-access memory (SRAM).

The bus 130 is a channel for transferring the image data among the DSP 110, the system memory 120, and an external device such as a camera, a flash memory device, and a display device. The camera interface 140, the memory interface 150, and the display interface 160 exchange data via the bus 130 between the image processing unit 100, the camera, the memory device, and the display device.

FIG. 2A is a block diagram illustrating a conventional compact camera port (CCP) interface. Referring to FIG. 2A, the CCP interface includes a CCP transmitting interface 210 and a CCP receiving interface 220.

The CCP transmitting interface 210 for transmitting a signal includes a first strobe terminal 212 and a first data terminal 214. The CCP receiving interface 220 includes a second strobe terminal 222 and a second data terminal 224, and is used for receiving the signal transmitted by the CCP transmitting interface 210.

FIG. 2B is a block diagram illustrating a conventional Mobile Graphic Coprocessor Interface (MGCI). Referring to FIG. 2B, the MGCI includes an MGCI transmitting interface 230 and an MGCI receiving interface 240. The MGCI transmitting interface 230 used for transmitting a signal includes a first strobe terminal 232, a first wakeup terminal 233, a first data terminal 234, and a second data terminal 236. The MGCI receiving interface 240 includes a second wakeup terminal 241, a second strobe terminal 242, a third wakeup terminal 243, a third data terminal 244, and a fourth data terminal 246, and is used for receiving the signal transmitted by the MGCI transmitting interface 230.

As described above, a mobile device employs a single type of interface, such as one of the CCP interface or the MGCI. Thus, an external device may not be coupled to the mobile device when an interface of the external device is different from the interface of the mobile device. For example, the mobile device having the CCP interface may not exchange data with an external device having the MGCI. Such different interfaces each exchange data according to different physical layer standards.

### SUMMARY OF THE INVENTION

Accordingly, a universal interface apparatus and method according to the present invention is for exchanging data with an external device having any of a multiple of physical layer standards. The universal interface apparatus includes a standard detection unit, a physical interface unit, and a data link selection unit. The standard detection unit automatically determines a specific physical layer standard for an external device.

The physical interface unit has an I/O (input/output) terminal coupled to the external device, and the I/O terminal includes a plurality of components with a respective set of the components being used according to the specific physical layer standard. The data link selection unit uses a respective data link layer standard corresponding to the specific physical layer standard, for a data link layer operation.

In one embodiment of the present invention, the standard detection unit exchanges a predetermined code with the external device, for automatically determining the specific physical layer standard.

In another embodiment of the present invention, the standard detection unit processes at least one signal applied by the external device at a predetermined pin of the I/O terminal, for automatically determining the specific physical layer standard.

In a further embodiment of the present invention, the standard detection unit determines a voltage difference during an I/O operation, for automatically determining the specific physical layer standard.

In yet another embodiment of the present invention, the specific physical layer standard is programmed into a memory device of the standard detection unit.

In an example embodiment of the present invention, the physical interface unit includes a physical/logical signal converter that converts a physical signal received from the external device into a logical signal, and that converts a logical signal to be outputted to the external device into a physical signal, according to the specific physical layer standard.

In another embodiment of the present invention, the physical interface unit further includes a serializer/deserializer (SERDES) unit that deserializes the logical signal received from the physical/logical signal converter and that serializes the logical signal received from the data link selection unit.

In a further embodiment of the present invention, the physical interface unit supports both of a Mobile Graphic Coprocessor Interface (MGCI) standard and a compact camera port (CCP) interface standard. In that case, a first set of components in the I/O terminal used for the MGCI standard has at least one common component with a second set of components in the I/O terminal used for the CCP interface standard.

The present invention may be used to particular advantage when the external device is for image processing in a mobile device.

In this manner, the universal interface apparatus and method allows for exchange of data with the external device operating according to one of a plurality of physical layer standards.

### BRIEF DESCRIPTION OF THE DRAWINGS

The above and other features and advantages of the present invention will become more apparent when described in detailed exemplary embodiments thereof with reference to the attached drawings in which:

FIG. 1 is a block diagram of a conventional image processing unit in a mobile device;

FIG. 2A is a block diagram of a conventional compact camera port (CCP) interface;

FIG. 2B is a block diagram of a conventional Mobile Graphic Coprocessor Interface (MGCI);

FIG. 3 is a block diagram of an image processing unit in a mobile device according to an example embodiment of the present invention;

FIG. 4 is a block diagram of the first universal interface of FIG. 3, according to an example embodiment of the present invention;

FIG. 5 is a block diagram of the physical interface unit in FIG. 4, according to an example embodiment of the present invention;

FIG. 6A is a block diagram of a receiving interface in an input/output (I/O) terminal of FIG. 5, according to an example embodiment of the present invention;

FIG. 6B is a block diagram of a transmitting interface in the input/output (I/O) terminal of FIG. 5, according to an example embodiment of the present invention;

FIG. 7 is a block diagram of a standard detection unit of FIG. 4 and an external device, according to an example embodiment of the present invention; and

FIG. 8 is a flowchart of steps during operation of the universal interface of FIG. 4, according to an example embodiment of the present invention.

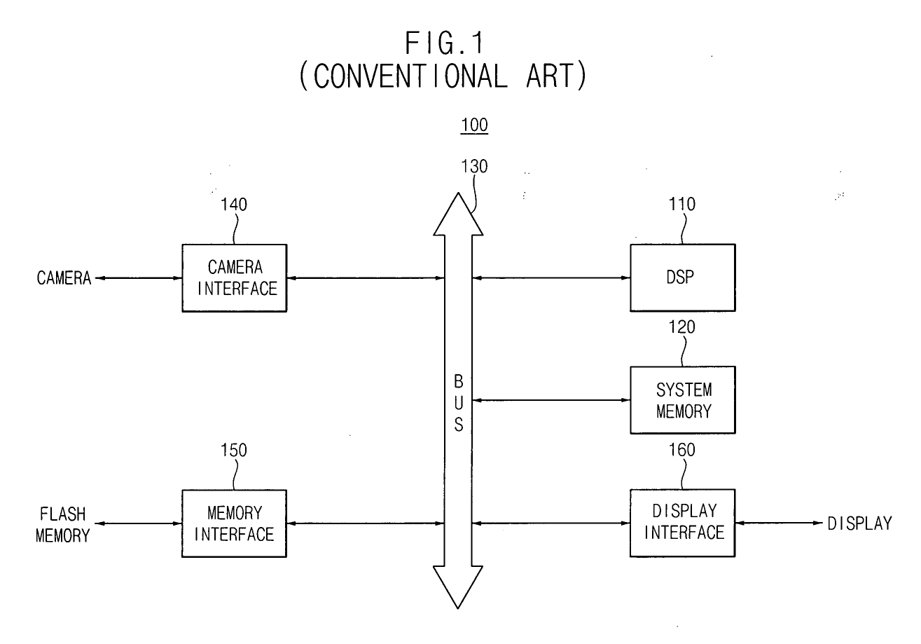

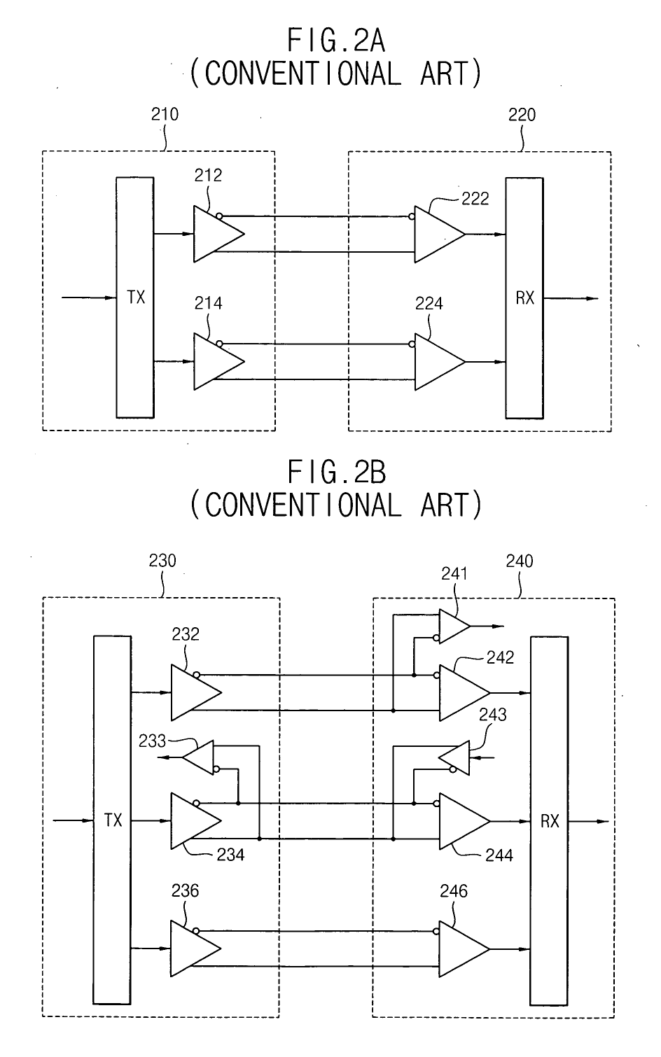

The figures referred to herein are drawn for clarity of illustration and are not necessarily drawn to scale. Elements having the same reference number in FIGS. 1, 2A, 2B, 3, 4, 5, 6A, 6B, 7, and 8 refer to elements having similar structure and/or function.

### DETAILED DESCRIPTION OF THE INVENTION

Detailed illustrative example embodiments of the present invention are disclosed herein. However, specific structural and functional details disclosed herein are merely representative for purposes of describing example embodiments of the present invention. This invention may, however, be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention now will be described more fully hereinafter with reference to the accompanying figures, in which embodiments of the invention are shown. However, it should be understood that there is no intent to limit the invention to the particular forms disclosed, but on the contrary, the invention is to cover all modifications, equivalents, and alternatives falling within the spirit and scope of the invention as defined by the claims.

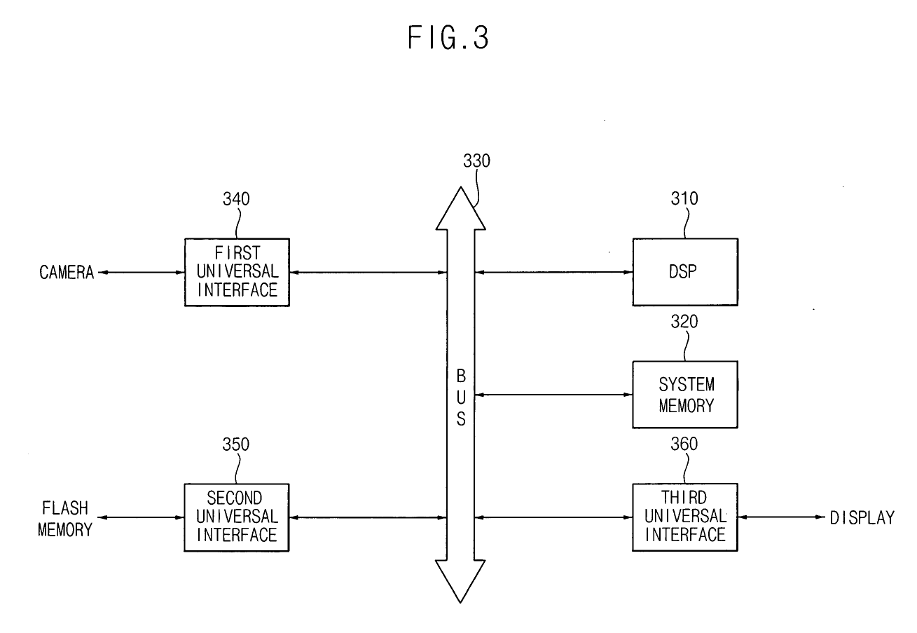

FIG. 3 is a block diagram of an image processing unit in a mobile device according to an example embodiment of the present invention. Referring to FIG. 3, the image processing unit includes a digital signal processor (DSP) 310, a system memory device 320, a bus 330, a first universal interface 340, a second universal interface 350, and a third universal interface 360.

The DSP 310 is a kind of a front-end processor for processing image data such as compression and/or decompression of the image data. For example, the DSP 310 receives image data from a camera via the first universal interface 340 to perform compression on the received image data. Additionally, the DSP 310 may be an advanced reduced instruction set computer (RISC) machine (ARM) processor that is included in a system-on-chip (SOC).

The system memory device 320 is a storage device for temporarily storing original image data or compressed image data from the DSP 310. The system memory device 320 may be a dynamic random-access memory (DRAM) device or a static random-access memory (SRAM) device. The bus 330 is a channel for transmitting the image data among the DSP 310, the system memory device 320, and external devices such as a camera, a flash memory device, and a display device.

The first universal interface 340, the second universal interface 350, and the third universal interface 360 are interfaces for the camera, the semiconductor memory device, and the display device, respectively. Each of such a camera, a semiconductor memory device (such as a flash memory device), and a display device is an external device for the mobile device. Each of the first, second, and third universal interfaces 340, 350, and 360 is a universal interface that supports a respective external device operating according to a respective one of a plurality of physical layer standards.

A procedure in which the mobile device stores an image data generated by the camera is now described. The DSP 310 receives the image data generated by the camera through the first universal interface 340 and the bus 330. The DSP 310 performs compression on the image data such as by employing an algorithm, that is, for the Joint Photographic Experts Group (JPEG) standard to compress still image data or for the Moving Picture Experts Group (MPEG) standard to compress moving image data.

The system memory device 320 may store the image data during the compression operation. The image data compressed by the DSP 310 is stored, through the second universal interface 350 and the bus 330, into the flash memory device coupled to the second universal interface 350.

Hereinafter, the first, second, and third universal interfaces 340, 350 and 360 are assumed to have a same configuration. However, the present invention may also be practiced when the first, second and third universal interfaces 340, 350 and 360 have different configurations from each other.

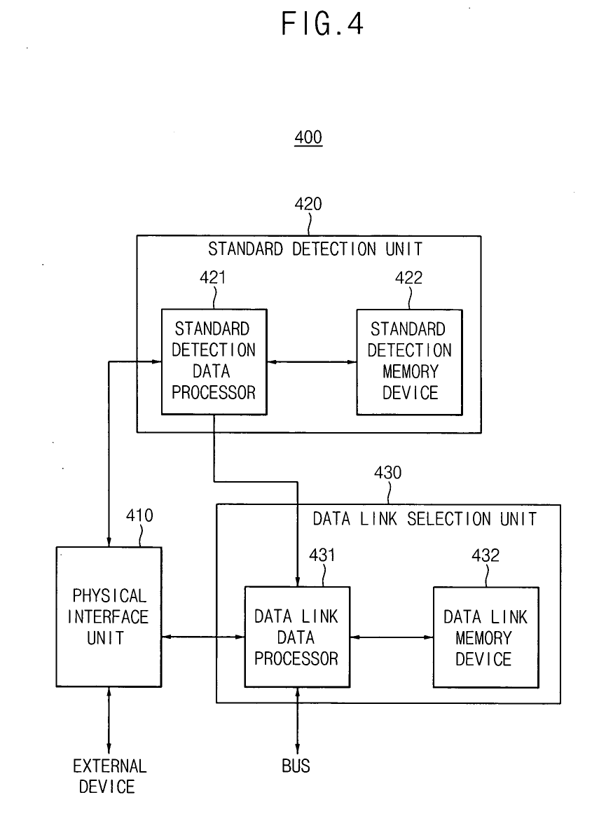

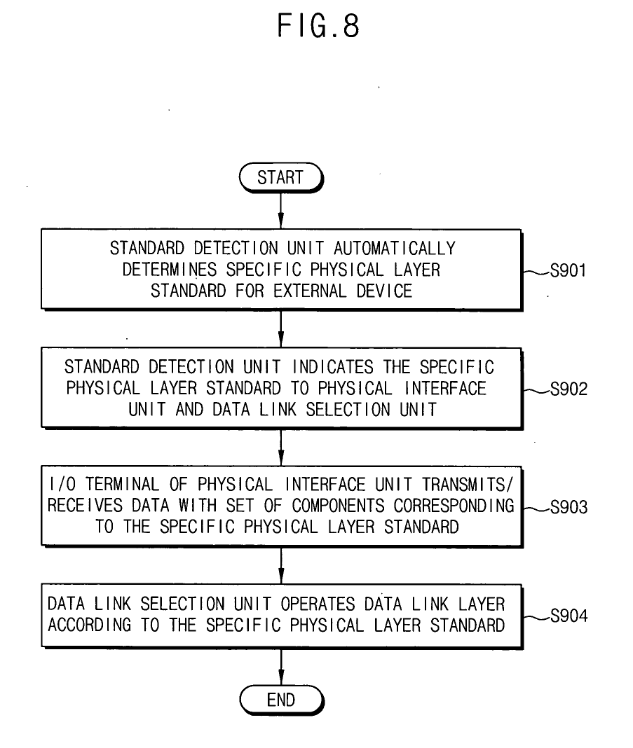

FIG. 4 is a block diagram of a universal interface apparatus 400 that is the first universal interface 340 of FIG. 3 according to an example embodiment of the present invention. The second and third interfaces 350 and 360 of FIG. 3 may also have the same such configuration of FIG. 4. FIG. 8 shows a flowchart of steps during operation of the universal interface apparatus 400.

Referring to FIG. 4, the universal interface 400 includes a physical interface unit 410, a standard detection unit 420, and a data link selection unit 430. The physical interface unit 410 allows for exchange of data via a single input/output (I/O) terminal with any of external devices operating according to a plurality of physical layer standards. Thus, the universal interface 400 may exchange data with any of various external devices such as the camera, the flash memory device, and the display device, operating according to different physical layer standards.

To that end, the physical interface unit 410 provides a number of I/O pins that accommodates for such plurality of physical layer standards. Thus, if the respective number of the I/O pins corresponding to each of the plurality of physical layer standards (such as the CCP interface standard and the MGCI standard) are different, the number of the I/O pins provided by the physical interface unit 410 is for the highest number of the I/O pins among the physical layer standards. The structure of the I/O pins of the external device may be arranged so that the physical interface unit 410 and the external device may be connected.

The standard detection unit 420 includes a standard detection data processor 421 and a standard detection memory device 422 having sequences of instructions (i.e. software) stored thereon. Execution of such sequences of instructions by the data processor 421 causes the data processor 421 to perform any operation/function attributed to the standard detection unit 420 as described herein.

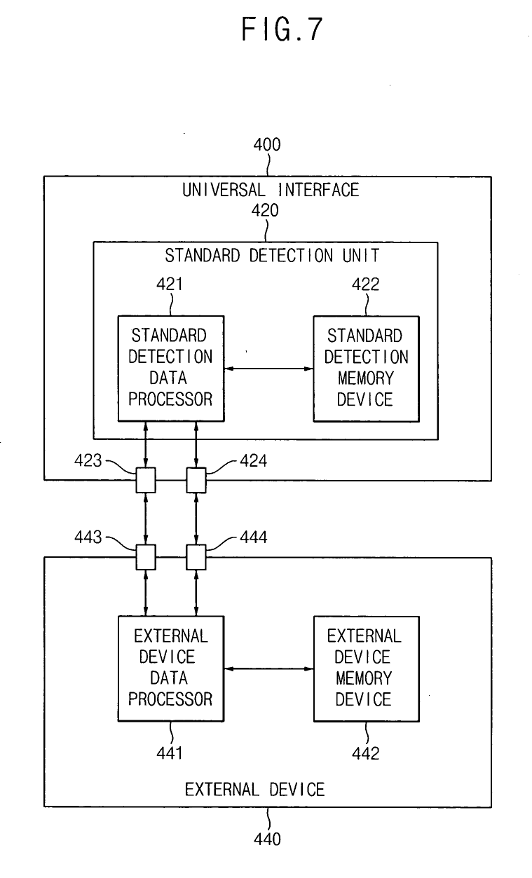

The standard detection unit 420 is coupled to the physical interface unit 410 and detects the specific physical layer standard corresponding to the external device coupled to the universal interface 400 (step S901 of FIG. 8). FIG. 7 shows a block diagram of an example external device 440 coupled to the universal interface 400.

The external device 440 includes an external device data processor 441 and an external device memory device 442 having sequences of instructions (i.e. software) stored thereon. Execution of such sequences of instructions by the data processor 441 causes the data processor 441 to perform any operation/function attributed to the external device 440 as described herein. The universal interface 400 includes I/O (input/output) pins 423 and 424 which may be part of the physical interface unit 410 coupled to I/O (input/output) pins 443 and 444 of the external device 440.

In one example embodiment of the present invention, the external device 440 sends a predetermined code via a predetermined one of the I/O pins 443 or 444 to indicate the specific physical layer standard of the external device 440. In that case, the standard detection unit 420 receives and analyzes such a predetermined code from the external device 440 for automatically determining the specific physical layer standard corresponding to the external device 440.

Generally, the external device 440 sends a signal to the universal interface 400 via a specific one of the I/O pins 443 and 444. In that case, the standard detection unit 420 receives and processes such a signal received at a corresponding I/O pin of the physical interface unit 410 for automatically determining the specific physical layer standard corresponding to the external device 440.

In another embodiment of the present invention, the standard detection unit 420 determines a voltage difference in performing a data I/O operation for automatically determining the specific physical layer standard corresponding to the external device 440. For example, the voltage difference between signals at the two I/O pins 443 and 444 may be determined for indicating the specific physical layer standard corresponding to the external device 440.

In a further embodiment of the present invention, an indication of the specific physical layer standard corresponding to the external device may be programmed into the standard detection memory device 422. In another embodiment of the present invention, the specific physical layer standard corresponding to the external device may be manually set by a user such as by switches or a register.

After the standard detection unit 420 determines the specific physical layer standard corresponding to the external device, the standard detection unit 420 communicates an indication of the specific physical layer standard of the external device to the physical interface unit 410 and the data link selection unit 430 (step S902 of FIG. 8).

The data link selection unit 430 includes a data link data processor 431 and a data link memory device 432 having sequences of instructions (i.e. software) stored thereon. Execution of such sequences of instructions by the data processor 431 causes the data processor 431 to perform any operation/function attributed to the data link selection unit 430 as described herein.

The data link selection unit 430 selects a data link layer standard corresponding to the specific physical layer standard of the external device. For example, if the specific physical layer of the external device is for the MDDI standard, the data link selection unit 430 selects a data link layer standard corresponding to the MDDI standard.

The data link layer controls a data transmission and detects a data error when the mobile device transmits/receives data to/from the external device. For example, the data link layer may use a cyclic redundancy check (CRC) code to detect the data error for requesting retransmission when the data error occurs. A data link layer individually and in general is known to one of ordinary skill in the art of SERDES data communications.

In summary, the physical interface unit 410 uses the specific physical layer standard and the data link selection unit 430 uses the data link layer standard for communication of data between the external device and the bus (step S903 and S904 of FIG. 8). A procedure in which the image generated by the camera as the external device is transmitted through the first universal interface 340 to the DSP 310 is described as follows.

The camera as the external device is coupled to the physical interface unit 410 of the first universal interface 340. The first universal interface 340 accommodates for any of the MGCI and CCP fast serial interface standards. The standard detection unit 420 determines the specific physical interface standard corresponding to the camera.

The data link selection unit 430 selects the data link layer standard corresponding to the specific physical layer standard of the camera. The image data from the camera is transmitted through the physical interface unit 410 according to the specific physical layer interface (step S903 of FIG. 8), and is thereafter transmitted through the data link layer to the bus according to the data link layer standard (step S904 of FIG. 8).

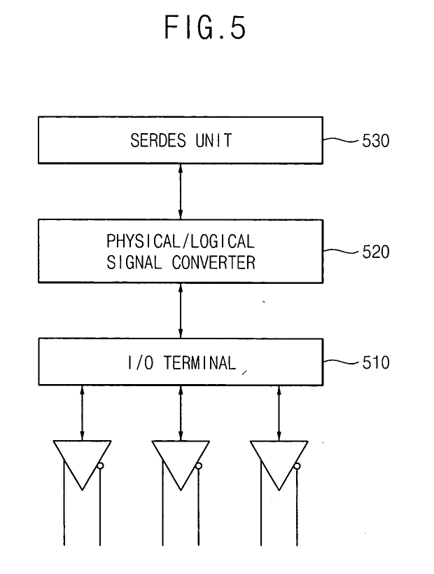

FIG. 5 is a block diagram of the physical interface unit 410 of FIG. 4, according to one embodiment of the present invention. Referring to FIG. 5, the physical interface unit 410 includes an I/O (input/output) terminal 510, a physical/logical signal converter 520, and a serializer/deserializer (SERDES) unit 530.

The I/O terminal 510 couples the external device to the mobile device via I/O pins. Thus, if the respective number of the I/O pins corresponding to each of the possible plurality of physical layer standards (such as the CCP interface standard and the MGCI standard) for the external device are different, the number of the I/O pins provided by the physical interface unit 410 is for the highest number of the I/O pins among the physical layer standards. In addition, the structure of the I/O pins of the external device may be arranged so that the physical interface unit 410 and the external device may be connected.

The physical/logical signal converter 520 converts a physical signal from the 1/0 terminal 510 into a logical signal, and converts the logical signal from the SERDES unit 530 into the physical signal for the I/O terminal 510. For example, when the external device coupled to the I/O terminal 510 operates according to the CCP interface standard, the physical/logical signal converter 520 converts the logical signal from the bus 330 into the physical signal corresponding to the CCP interface standard for the I/O terminal 510. On the other hand, the physical/logical signal converter 520 converts the physical signal from the I/O terminal 510 into the logical signal to be transmitted on the bus 330 when the I/O terminal 510 transmits the physical signal.

Generally, the physical layer relates to a setup and maintenance of the connection and the disconnection, between the mobile device and the universal interface. Attributes of the physical layer may be classified into an electrical attribute, a functional attribute, a mechanical attribute, and a procedural attribute. A physical layer individually and in general is known to one of ordinary skill in the art of SERDES data communications.

The electrical attribute describes a voltage or current for representing a data value of ‘0’ or ‘1’ , and a timing of the electrical signal. The functional attribute describes function performed according to the physical layer standard, such as control, timing, and so on. The mechanical attribute describes a circuit between the external device and the mobile device. The procedural attribute describes a sequence performed for exchanging data.

The SERDES unit 530 deserializes data transmitted to the mobile device from the external device and serializes data transmitted to the external device from the mobile device based on a corresponding fast serial interface standard. For example, the fast serial interface may be for the MGCI standard or the CCP interface standard.

Firstly, a procedure in which the mobile device stores an image generated by the camera is described as follows. The camera having an MDDI interface is coupled to the I/O terminal 510. The physical/logical signal converter 520 converts the physical signal into the logical signal corresponding to the MDDI interface. The SERDES unit 530 deserializes data of the logical signal corresponding to the MDDI interface.

The data link selection unit 430 selects a data link layer corresponding to the MDDI interface and transmits the serialized image data to the DSP 310 through the bus 330 and the first universal interface 340. Consequently, the image data generated by the camera is transmitted to the DSP 310 through the first universal interface 340.

Secondly, a procedure in which the mobile device stores image data into the flash memory device is described as follows. The DSP 310 transmits the image to the second universal interface 350 through the bus 330.

The data link selection unit 430 selects the data link layer standard corresponding to the flash memory device as the external device. The SERDES unit 530 serializes the image received through the data link selection unit 430.

The physical/logical signal converter 520 receives the serialized image data to convert the received data into a physical signal. The I/O terminal 510 transmits the physical signal to the flash memory device.

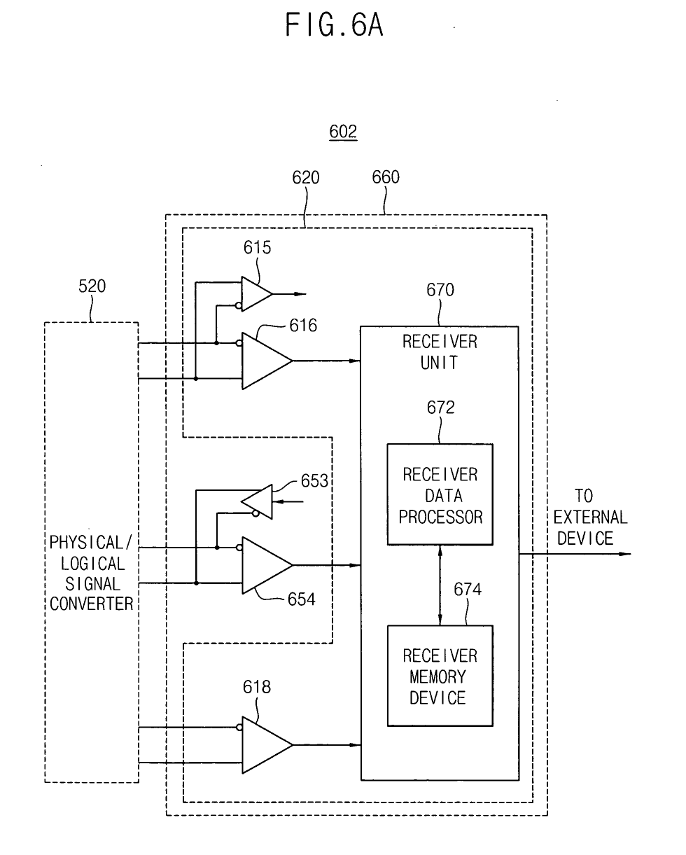

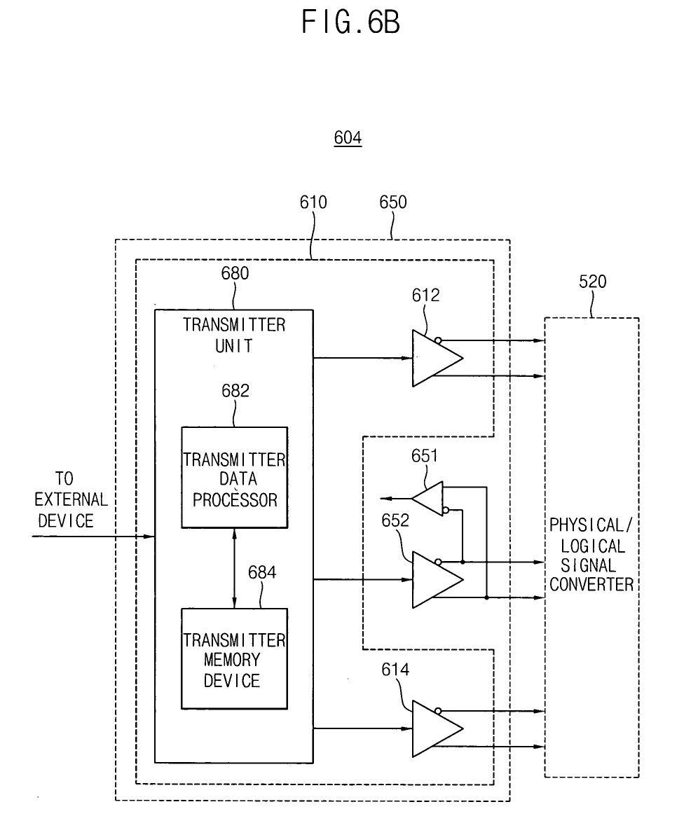

FIG. 6A is a block diagram of a receiving interface 602 in the I/O terminal 510 of FIG. 5. Referring to FIG. 6A, the receiving interface 602 includes components for a CCP receiving interface 620 (shown within dashed lines) and components for a MGCI receiving interface 660 (shown within dashed lines).

A first set of components for forming the CCP receiving interface 620 includes a first wakeup terminal 615, a second strobe terminal 616 and a second data terminal 618, that receive data according to the CCP interface standard. A second set of components for forming the MGCI receiving interface 660 includes the first wakeup terminal 615, the second strobe terminal 616, a third wakeup terminal 653, a fourth data terminal 654, and the second data terminal 618, that receive data according to the MGCI standard. Such first and second sets of components have at least one common component according to an aspect of the present invention.

The receiving interface 602 also includes a receiver unit 670 with a receiver data processor 672 and a receiver memory device 674 having sequences of instructions (i.e. software) stored thereon. Execution of such sequences of instructions by the data processor 672 causes the data processor 672 to perform any operation/function attributed to the receiver unit 670 as described herein.

The receiver unit 670 transfers data from the CCP receiving interface 620 to the external device when the standard detection unit 420 determines that the external device operates according to the CCP interface standard. The receiver unit 670 transfers data from the MGCI receiving interface 660 to the external device when the standard detection unit 420 determines that the external device operates according to the MGCI standard.

FIG. 6B is a block diagram of a transmitting interface 604 in the I/O terminal 510 of FIG. 5. Referring to FIG. 6B, the transmitting interface 604 includes components for a CCP transmitting interface 610 (shown within dashed lines) and components for a MGCI transmitting interface 650 (shown within dashed lines).

A first set of components for forming the CCP transmitting interface 610 includes a first strobe terminal 612 and a first data terminal 614, that transmit data according to the CCP interface standard. A second set of components for forming the MGCI transmitting interface 650 includes the first strobe terminal 612, a second wakeup terminal 651, a third data terminal 652, and the first data terminal 614, that transmit data according to the MGCI standard. Such first and second sets of components have at least one common component according to an aspect of the present invention.

The transmitting interface 604 also includes a transmitter unit 680 with a transmitter data processor 682 and a transmitter memory device 684 having sequences of instructions (i.e. software) stored thereon. Execution of such sequences of instructions by the data processor 682 causes the data processor 682 to perform any operation/function attributed to the transmitter unit 680 as described herein.

The transmitter unit 680 transfers data from the external device to the CCP transmitting interface 610 when the standard detection unit 420 determines that the external device operates according to the CCP interface standard. The transmitter unit 680 transfers data from the external device to the MGCI receiving interface 650 when the standard detection unit 420 determines that the external device operates according to the MGCI interface standard.

In this manner, the universal interface apparatus 400 performs I/O operations for an external device operating according to any of a plurality of physical layer interface standards. The foregoing is by way of example only and is not intended to be limiting. For example, any numbers or number of elements described and illustrated herein is by way of example only. The present invention is limited only as defined in the following claims and equivalents thereof.

What is claimed is:

1. A universal interface apparatus comprising:
a standard detection unit for automatically determining a specific physical layer standard for an external device;
a physical interface unit having an I/O (input/output) terminal coupled to the external device, wherein the I/O terminal includes a plurality of components with a respective set of the components being used according to the specific physical layer standard; and
a data link selection unit that uses a respective data link layer standard corresponding to the specific physical layer standard, for a data link layer operation.

2. The universal interface apparatus of claim 1, wherein the standard detection unit exchanges a predetermined code with the external device, for automatically determining the specific physical layer standard.

3. The universal interface apparatus of claim 1, wherein the standard detection unit processes at least one signal applied by the external device at a predetermined pin of the I/O terminal, for automatically determining the specific physical layer standard.

4. The universal interface apparatus of claim 1, wherein the standard detection unit determines a voltage difference during an I/O operation, for automatically determining the specific physical layer standard.

5. The universal interface apparatus of claim 1, wherein the specific physical layer standard is programmed into a memory device of the standard detection unit.

6. The universal interface apparatus of claim 1, wherein the physical interface unit includes:
a physical/logical signal converter that converts a physical signal received from the external device into a logical signal, and that converts a logical signal to be outputted to the external device into a physical signal, according to the specific physical layer standard.

7. The universal interface apparatus of claim 6, wherein the physical interface unit further includes:
a serializer/deserializer (SERDES) unit that deserializes the logical signal received from the physical/logical signal converter and that serializes the logical signal received from the data link selection unit.

8. The universal interface apparatus of claim 1, wherein the physical interface unit supports both of a Mobile Graphic Coprocessor Interface (MGCI) standard and a compact camera port (CCP) interface standard.

9. The universal interface apparatus of claim 8, wherein a first set of components in the I/O terminal used for the MGCI standard has at least one common component with a second set of components in the I/O terminal used for the CCP standard.

10. The universal interface apparatus of claim 8, wherein the external device is for image processing in a mobile device.

11. A universal interface method, comprising:
determining a specific physical layer standard for an external device;
determining a respective data link layer standard depending on the specific physical layer standard; and
performing an I/O operation with the external device according to the specific physical layer standard and the respective data link layer standard.

12. The universal interface method of claim 11, further comprising:
selecting a respective set of components of an I/O (input/output) terminal used for interfacing with the external device according to the specific physical layer standard.

13. The universal interface method of claim 12, wherein the I/O terminal supports both of a Mobile Graphic Coprocessor Interface (MGCI) standard and a compact camera port (CCP) interface standard.

14. The universal interface method of claim 13, wherein a first set of components in the I/O terminal used for the MGCI standard has at least one common component with a second set of components in the I/O terminal used for the CCP interface standard.

15. The universal interface method of claim 11, further comprising:
exchanging a predetermined code with the external device for automatically determining the specific physical layer standard.

16. The universal interface method of claim 11, further comprising:
processing at least one signal applied by the external device at a predetermined pin of the I/O terminal for automatically determining the specific physical layer standard.

17. The universal interface method of claim 11, further comprising:
determining a voltage difference during an I/O operation for automatically determining the specific physical layer standard.

18. The universal interface method of claim 11, further comprising:
reading an indication of the specific physical layer standard from a memory device for automatically determining the specific physical layer standard.

19. The universal interface method of claim 11, further comprising:
converting a physical signal received from the external device into a logical signal, according to the specific physical layer standard; and
converting a logical signal to be outputted to the external device into a physical signal, according to the specific physical layer standard.

20. The universal interface method of claim 19, wherein the physical interface unit further includes:
deserializing the logical signal to be transmitted to a bus, and serializing the logical signal received from the bus.
